(19) United States
(12) Patent Application Publication
(10) Pub. No.: US 2015/0015473 A1
(43) Pub. Date: Jan. 15, 2015

(54) DISPLAY DRIVING CIRCUIT AND DISPLAY DEVICE

(71) Applicant: SILICON WORKS CO., LTD., Daejeon-si (KR)

(72) Inventors: Hark Jin JUNG, Incheon-si (KR); Ki Sun JUNG, Seongnam-si (KR); Hyun Ho CHO, Incheon-si (KR); Joon Ho NA, Daejeon-si (KR); Hyun Kyu JEON, Daejeon-si (KR); Yong Icc JUNG, Bucheon-si (KR)

(21) Appl. No.: 14/327,885

(22) Filed: Jul. 10, 2014

(30) Foreign Application Priority Data
Jul. 12, 2013 (KR) 10-2013-0082309

(51) Int. Cl. G09G 3/36

(52) U.S. Cl. CPC G09G 3/3648; G09G 3/3611
USPC 345/98

(57) ABSTRACT

Disclosed are a display driving circuit and a display device. The display driving circuit includes an output buffer unit that outputs a pair of pixel signals, an output switch unit that directly transfers the pair of pixel signals to a pair of output lines or transfers the pair of pixel signals to the pair of output lines such that the pair of pixel signals cross each other in correspondence with repetitive panel charging/discharging periods, and a charge sharing switch unit that controls charge sharing of the pair of output lines in correspondence with a charge sharing period between the panel charging/discharging periods, and provides a variable connection resistance value for the charge sharing. Consequently, power consumption and heat generation of the display driving circuit are reduced.

### BACKGROUND

1. Technical Field

The present disclosure relates to a display driving technology, and more particularly, to a display driving circuit for reducing power consumption and heat generation.

2. Related Art

A display driving circuit operates in an AC driving scheme in order to prevent image sticking that may occur when polarity material existing in a display panel is attached to an electrode. Furthermore, the display driving circuit uses an inversion (or polarity inversion) driving scheme in order to control a flicker phenomenon that occurs by parasitic capacitance of thin film transistors (TFTs) arranged in the display panel.

The conventional display driving circuit selectively supplies buffered pixel signals to output lines according to the inversion driving scheme. Furthermore, in order to reduce power consumption required for buffering pixel signals, the conventional display driving circuit may interconnect the output lines and pre-drive an output voltage to an intermediate potential (for example, a common voltage Vcom) during the time for which data signals, that is, pixel signals are not applied to the display panel.

FIG. 1 is a waveform diagram illustrating the output of the conventional display driving circuit.

Referring to FIG. 1, the conventional display driving circuit provides a display panel with an output voltage Vout that is changed according to the passage of time. The conventional display driving circuit may supply a pixel signal to the display panel in a panel charging/discharging period t1, and pre-drive the output voltage to an intermediate potential Vcom through a connection between output lines in a charge sharing period t2, that is, charge sharing.

The panel charging/discharging period t1 corresponds to a time range in which valid data, that is, the pixel signal is supplied to the display panel, and the charge sharing period t2 corresponds to a time range arbitrarily set such that charge is shared between the output lines before the pixel signal is supplied. The pixel signal corresponds to image data that is applied to the display panel and is actually realized.

The conventional display driving circuit provides the display panel with a pixel signal having a voltage that is changed from the common voltage Vcom, which is an intermediate voltage between a first polarity (+) and a second polarity (−), to the first polarity (+), or provides the display panel with a pixel signal having a voltage that is changed from the common voltage Vcom to the second polarity (−). Consequently, the conventional display driving circuit can reduce the amount of power consumption as compared with a technology for changing the voltage of a pixel signal from the first polarity (+) to the second polarity (−).

However, in the conventional display driving circuit, since a shift from the first polarity (+) to the common voltage Vcom occurs or a shift from the second polarity (−) to the common voltage Vcom occurs even in a period in which there is no polarity inversion, there is a problem that power may be unnecessarily consumed.

### SUMMARY

Various embodiments are directed to a display driving circuit capable of minimizing power consumption and heat generation.

Also, various embodiments are directed to a display driving circuit capable of controlling the amount of charge that is shared according to the inversion or non-inversion of a polarity of a display panel.

In an embodiment, a display driving circuit may include: an output buffer unit that outputs a pair of pixel signals; an output switch unit that directly transfers the pair of pixel signals to a pair of output lines or transfers the pair of pixel signals to the pair of output lines such that the pair of pixel signals cross each other in correspondence with repetitive panel charging/discharging periods; and a charge sharing switch unit that controls charge sharing of the pair of output lines in correspondence with a charge sharing period between the panel charging/discharging periods, and has a variable connection resistance value in correspondence with the variation of the pair of pixel signals.

In an embodiment, a display driving circuit may include: an output buffer unit that outputs a plurality of pixel signal pairs; an output switch unit that directly transfers the plurality of pixel signal pairs to a plurality of output line pairs or transfers the plurality of pixel signal pairs to the plurality of output line pairs such that the plurality of pixel signal pairs cross each other in units of pairs corresponding to each other; a charge sharing switch unit that includes at least one switch that operates for charge sharing in units of pairs corresponding to each other of the plurality of output line pairs, and provides a variable connection resistance value by an operation of the switch; and a control unit that controls operations of the output switch unit and the charge sharing switch unit.

In an embodiment, a display device may include: a display panel; and a display driving circuit that drives the display panel, wherein the display driving circuit may include: an output buffer unit that outputs a pair of pixel signals; an output switch unit that directly transfers a pair of pixel signals to a pair of output lines or transfers the pair of pixel signals to the pair of output lines such that the pair of pixel signals cross each other; a charge sharing switch unit that includes at least one switch that operates for charge sharing of the pair of output lines, and provides a variable connection resistance value by an operation of the switch; and a control unit that controls operations of the output switch unit and the charge sharing switch unit.

A display driving circuit according to an embodiment of the present invention can reduce current consumption and heat generation through a charge sharing switch.

The display driving circuit according to an embodiment of the present invention can control a connection resistance value of the charge sharing switch, thereby controlling the amount of charge that is shared according to the polarity inversion or polarity non-inversion of a display panel.

### BRIEF DESCRIPTION OF THE DRAWINGS

FIG. 1 is a waveform diagram illustrating the output of a conventional display driving circuit.

FIG. 2 is a diagram illustrating a display driving circuit according to an embodiment of the present invention.

FIG. 3 is a waveform diagram illustrating the output of a display driving circuit in FIG. 2.

FIG. 4A to FIG. 4C are a waveform diagram illustrating the operation of a charge sharing switch unit according to a change in the output of a display driving circuit in FIG. 2.

FIG. 5 is a diagram illustrating a display driving circuit according to another embodiment of the present invention.

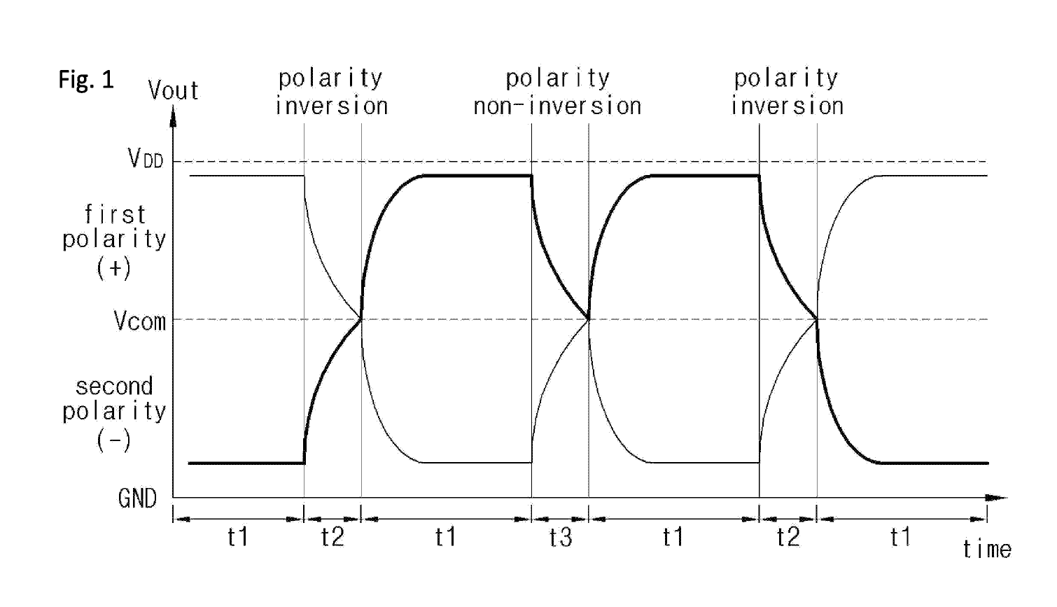

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

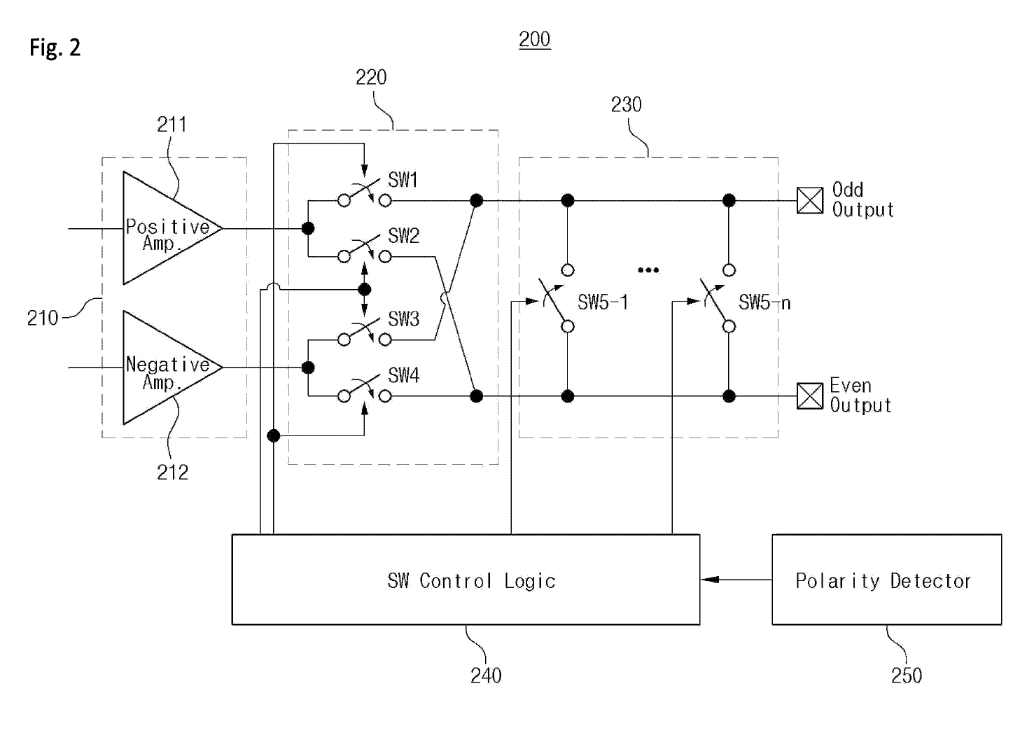

FIG. 2 is a diagram illustrating a display driving circuit according to an embodiment of the present invention.

Referring to FIG. 2, a display driving circuit 200 generates pixel signals and transfers the pixel signals to a display panel (not illustrated), and includes an output buffer unit 210, an output switch unit 220, a charge sharing switch unit 230, and a control unit 240.

The output buffer unit 210 includes a pair of output buffers 211 and 212 that buffer and output the pixel signals. The first output buffer 211 has a first voltage driving potential and the second output buffer 212 has a second voltage driving potential. The first output buffer 211 and the second output buffer 212 may be called a positive (+) buffer and a negative (−) buffer, respectively, and the first voltage driving potential may be equal to the second voltage driving potential, or may be higher than the second voltage driving potential.

For example, the first and second voltage driving potentials may correspond to 0 V and 10 V, respectively, and for another example, the first voltage driving potential may correspond to 5 V to 10 V and the second voltage driving potential may correspond to 0 V to 5 V.

In an embodiment, the first and second voltage driving potentials may be symmetrical to each other about a specific voltage driving potential. For example, when the specific voltage driving potential corresponds to 5 V and supply voltages (for example, VDD and GND) input to the first and second output buffers 211 and 212 correspond to 10 V and 0 V, respectively, the first voltage driving potential may correspond to 5 V to 10 V, and the second voltage driving potential may correspond to 0 V to 5 V.

In an embodiment, each of the first and second output buffers 211 and 212 may be implemented with a unity gain buffer or an amplifier.

The output switch unit 220 may selectively connect the first output buffer 211 to a first output line (odd output) corresponding to an odd column of the display, or a second output line (even output) corresponding to an even column thereof. Simultaneously, the output switch unit 220 may selectively connect the second output buffer 212 to the second output line (even output) or the first output line (odd output).

The output switch unit 220 may transfer the output of the output buffer unit 210 to the display panel (not illustrated), and may correspond to a switching circuit for polarity inversion for preventing a sticking phenomenon of a display liquid crystal.

The output switch unit 220 includes at least one switch that is positioned between the output buffer unit 210 and the output lines (the odd output and the even output), is electrically connected to them, and may be selectively connected to the output lines (the odd output and the even output) according to a control signal.

Referring to FIG. 2, the output switch unit 220 may include a first switch SW1 between the first output buffer 211 and the first output line (odd output), a second switch SW2 between the first output buffer 211 and the second output line (even output), a third switch SW3 between the second output buffer 212 and the first output line (odd output), and a fourth switch SW4 between the second output buffer 212 and the second output line (even output).

In an embodiment, the output switch unit 220 operates (On) in a first panel charging/discharging period and does not operate (Off) in a charge sharing period. The output switch unit 220 directly connects the pair of output buffers 211 and 212 to the output lines (the odd output and the even output) when the potential polarities of the output lines (the odd output and the even output) in a second panel charging/discharging period are equal to those in the first panel charging/discharging period (hereinafter, referred to as “polarity non-inversion”). The output switch unit 220 connects the pair of output buffers 211 and 212 to the output lines (the odd output and the even output) such that they cross each other when the potential polarities of the output lines (the odd output and the even output) in the second panel charging/discharging period are different from those in the first panel charging/discharging period (hereinafter, referred to as “polarity inversion”). The operation indicates that the output switch unit 220 is turned on.

In other words, the output switch unit 220 may operate according to a control signal that is output from the control unit 240. In more detail, the output switch unit 220 may operate in the following three types according to the control signal.

First, in a pixel signal transmission period, that is, a charging or discharging period of the display panel (hereinafter, referred to the “panel charging/discharging period”), the output switch unit 220 receives a first control signal from the control unit 240, and turns on the first switch SW1 to connect the first output buffer 211 to the first output line (the odd output), thereby allowing a pixel signal to be transmitted to a corresponding pixel through the first output line (the odd output). Simultaneously, the output switch unit 220 turns on the fourth switch SW4 to connect the second output buffer 212 to the second output line (the even output).

Second, in the panel charging/discharging period and the polarity inversion period, the output switch unit 220 receives a second control signal from the control unit 240, and turns on the second switch SW2 to connect the first output buffer 211 to the second output line (the even output), and turns on the third switch SW3 to connect the second output buffer 212 to the first output line (the odd output).

Third, in the charge sharing period, the output switch unit 220 receives a third control signal from the control unit 240, and turns off all the first to fourth switches SW1 to SW4, thereby blocking the transfer of the pixel signal through the output lines (the odd output and the even output).

The charge sharing switch unit 230 connects the pair of output lines (the odd output and the even output) to each other. In more detail, the charge sharing switch unit 230 may include at least one charge sharing switch, and connect/disconnect the first and second output lines (the odd output and the even output) to/from each other. When the charge sharing switch unit 230 includes two or more charge sharing switches, the charge sharing switches are connected in parallel to each other.

In more detail, the charge sharing switch unit 230 connects the first and second output lines (the odd output and the even output) to each other in the charge sharing period, and disconnects the first and second output lines (the odd output and the even output) from each other in the panel charging/discharging period.

At this time, the pair of output lines (the odd output and the even output) share charge according to the operation of the charge sharing switch unit 230, so that it is possible to reduce the power consumption of the display driving circuit 200.

In the charge sharing period, the switch in the charge sharing switch unit 230 is turned on, so that the output lines (the odd output and the even output) are connected to each other, share charge discharged from the display panel through the charge sharing switch unit 230, and maintain the same potential.

In the panel charging/discharging period, the switch in the charge sharing switch unit 230 is turned off, so that the charge sharing between the output lines (the odd output and the even output) is ended. That is, the charge transfer or sharing between the output lines (the odd output and the even output) is blocked. At this time, the pixel signal of the output switch unit 220 is supplied to the pair of output lines (the odd output and the even output).

In an embodiment, the charge sharing switch unit 230 has variable connection resistance (or turn-on resistance) according to a change in the polarities of pixel signals that are output from the output lines (the odd output and the even output), wherein the connection resistance value may be large in the case in which there is no polarity change as compared with the case in which there is a polarity change.

For example, the charge sharing switch unit 230 may have variable connection resistance with resistance values of 0.5 KΩ and 2 KΩ in the polarity inversion and polarity non-inversion of the output lines (the odd output and the even output). The charge sharing switch unit 230 may have a large resistance value in the case of the polarity non-inversion as compared with the case of the polarity inversion, thereby relatively reducing the amount of charge shared by the output lines. As a consequence, a change width of an output voltage can be relatively reduced.

In an embodiment, the charge sharing switch unit 230 may include a first charge sharing switch SW5-1 that is turned on in the charge sharing period and interconnects the pair of output lines (the odd output and the even output), and a plurality of second charge sharing switches SW5-n that are turned on when the potential polarities of the output lines in the charge sharing period are changed (hereinafter, referred to as “polarity inversion”), and interconnect the pair of output lines (the odd output and the even output).

Each of the first and second charge sharing switches SW5-1 and SW5-n has connection resistance, wherein the connection resistance value of the first charge sharing switch SW5-1 may be larger than the connection resistance values of the second charge sharing switches SW5-n. The aforementioned connection resistance may include turn-on resistance of the first and second charge sharing switches SW5-1 and SW5-n, wherein the turn-on resistance may be understood as channel resistance values of transistors constituting the first and second charge sharing switches SW5-1 and SW5-n.

The charge sharing switch unit 230 has a relatively small connection resistance value in the polarity inversion, and pre-drives an output voltage to an intermediate potential Vcom through quick charge sharing between the pair of output lines (the odd output and the even output). Furthermore, the charge sharing switch unit 230 has a relatively large connection resistance value in the polarity non-inversion, and can reduce a change width of the output voltage through delayed charge sharing between the pair of output lines (the odd output and the even output), thereby reducing power consumption of the display driving circuit.

For example, when the connection resistance of the first and second charge sharing switches SW5-1 and SW5-n is 2 KΩ and 0.5 KΩ, the charge sharing switch unit 230 may turn on the first and second charge sharing switches SW5-1 and SW5-n in the polarity inversion and have total connection resistance of 0.4 KΩ (=(2*0.5)/(2+0.5)) through a parallel connection of internal resistors, and may turn on only the first charge sharing switch SW5-1 in the polarity non-inversion and have total connection resistance of 2 KΩ.

For another example, when the charge sharing switch unit 230 includes charge sharing switches SW5-1 to SW5-5 with the same resistance value of 2 KΩ, a bundle of the four charge sharing switches SW5-2 and SW5-5 may be operated as a second charge sharing switch. In this case, the second charge sharing switches SW5-2 to SW5-5 may have connection resistance of 0.5 KΩ (=2/4) as four connection resistors are connected in parallel to each other. As a consequence, the same may be realized similarly to the aforementioned example.

The control unit 240 controls the operations of the output switch unit 220 and the charge sharing switch unit 230.

In more detail, the control unit 240 may control the operations of the output switch unit 220 and the charge sharing switch unit 230 based on the passage of time (for example, the charge sharing period and the panel charging/discharging period) and the presence or absence of polarity inversion.

In an embodiment, the control unit 240 may generate a control signal for operating the output switch unit 220 and turning off the charge sharing switch unit 230 in the panel charging/discharging period, and turning off the output switch unit 220 and operating the charge sharing switch unit 230 in the charge sharing period.

Referring to FIG. 2, the control unit 240 may provide the aforementioned control signal to the output switch unit 220 and the charge sharing switch unit 230. By the control signal of the control unit 240, in the panel charging/discharging period, the first and fourth switches SW1 and SW4 or the second and third switches SW2 and SW3 of the output switch unit 220 may be turned on, and the charge sharing switch unit 230 may be turned off. By the control signal of the control unit 240, when there is polarity non-inversion in a panel charging/discharging period next to the charge sharing period, the output switch unit 220 may be turned off and the first charge sharing switch SW5-1 of the charge sharing switch unit 230 may be turned on in the charge sharing period. Furthermore, by the control signal of the control unit 240, when there is polarity inversion in the panel charging/discharging period next to the charge sharing period, the output switch unit 220 may be turned off and the first charge sharing switch SW5-1 and the second charge sharing switches SW5-n of the charge sharing switch unit 230 may be turned on in the charge sharing period.

In the case of the polarity non-inversion in the charge sharing period, the control unit 240 may change the connection resistance value of the charge sharing switch unit 230 or decide the number of the charge sharing switches SW5-1 to SW5-n participating in charge sharing.

In an embodiment, the control unit 240 may change the connection resistance value of the charge sharing switch unit 230 or decide the number of the charge sharing switches SW5-1 to SW5-n participating in charge sharing based on information on the power consumption and heat generation of the display driving circuit 200 for a specific time. The control unit 240 may periodically receive the information on the power consumption and heat generation of the display driving circuit 200 from an exterior.

When the power consumption or heat generation of the display driving circuit 200 is large, the difference between the voltages of the output lines (the odd output and the even output) and the common voltage Vcom is relatively large as with a white screen. In this case, the control unit 240 may control only a part of the charge sharing switches SW5-1 to SW5-n to participate in charge sharing.

When the power consumption or heat generation of the display driving circuit 200 is small, the difference between the voltages of the output lines (the odd output and the even output) and the common voltage Vcom is relatively small as with a black screen. In this case, the control unit 240 may control a selected number of charge sharing switches or all the charge sharing switches SW5-1 to SW5-n to participate in charge sharing.

For example, when the charge sharing switch unit 230 includes five charge sharing switches SW5-1 to SW5-5, the control unit 240 may control the operations of the charge sharing switches SW5-1 to SW5-5 based on a switch control table according to power consumption.

Table 1 below indicates the number of charge sharing switches that participate in charge sharing according to power consumption and heat generation in the polarity non-inversion of the charge sharing period.

TABLE 1

| | | | | | |
|---|---|---|---|---|---|
| Power | 0 to | 300 to | 600 to | 900 to | 1200 to |
| consumption | 300 | 600 | 900 | 1200 | 1500 |
| [mW] | | | | | |
| Driving circuit | 0 to | 30 to | 60 to | 90 to | 120 to |
| temperature | 30 | 60 | 90 | 120 | 150 |
| [° C.] | | | | | |
| Number of | 5 | 4 | 3 | 2 | 1 or 0 |
| charge sharing | | | | | |
| switches | | | | | |

Referring to Table 1, when the power consumption of the display driving circuit 200 for a specific time is 1300 mW, the control unit 240 may control only one charge sharing switch SW5-1 to operate, and when the power consumption of the display driving circuit 200 for a specific time is 500 mW, the control unit 240 may control four charge sharing switches SW5-1 to SW5-4 to operate.

For another example, when the charge sharing switch unit 230 includes five charge sharing switches SW5-1 to SW5-5, the control unit 240 may control the operations of the charge sharing switches SW5-1 to SW5-5 according to a power consumption variation.

When the display is initially driven, the control unit 240 may control a predetermined number of charge sharing switches to participate in charge sharing. Then, after a specific time passes, when the power consumption exceeds a specific value (for example, 300 mW) and increases, the control unit 240 may exclude one charge sharing switches from the charge sharing. However, after a specific time passes, when the power consumption decreases under a specific value (for example, 300 mW), the control unit 240 may control one charge sharing switches to additionally participate in the charge sharing.

Consequently, the display driving circuit 200 can dynamically control the connection resistance of the charge sharing switch unit 230 or the number of charge sharing switches SW5-1 to SW5-n participating in charge sharing according to power consumption, thereby reducing power consumption and heat generation.

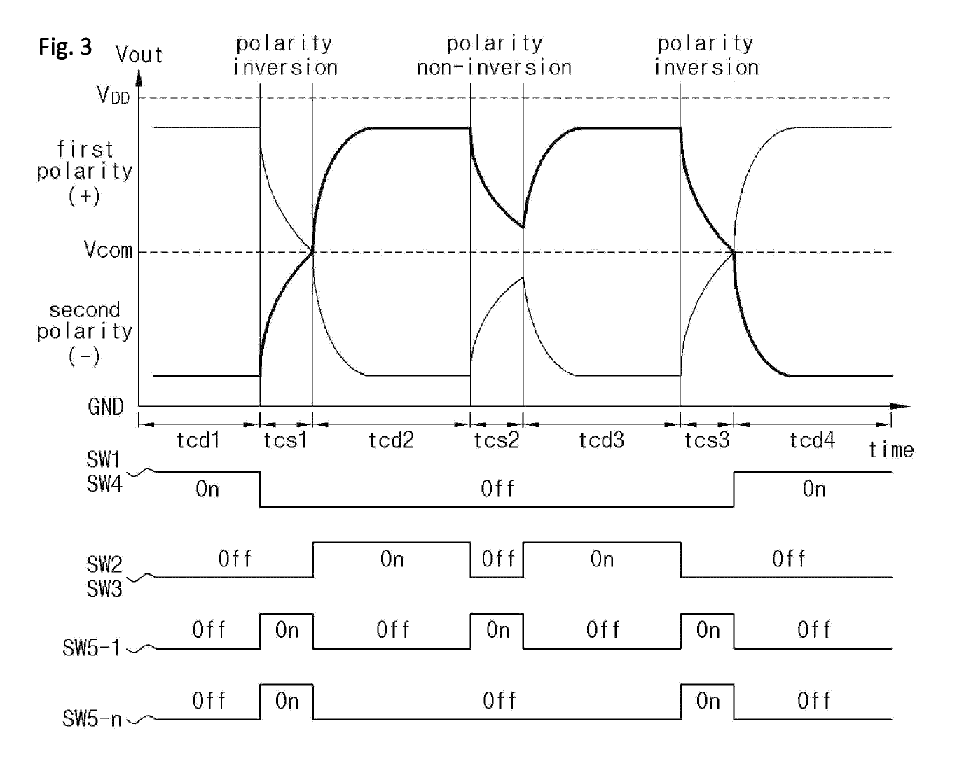

FIG. 3 is a waveform diagram illustrating the output of the display driving circuit in FIG. 2.

Referring to FIG. 3, in the first panel charging/discharging period tcd1, the output switch unit 220 is turned on under the control of the control unit 240, and supplies a pixel signal, which is output from the output buffer unit 210, to the output lines. At this time, the charge sharing switch unit 230 is turned off under the control of the control unit 240.

When the first panel charging/discharging period tcd1 is changed to the first charge sharing period tcs1 in which there is polarity inversion, the output switch unit 220 is turned off under the control of the control unit 240, and the pixel signal output from the output buffer unit 210 is not transferred to the display panel (not illustrated). At this time, the charge sharing switch unit 230 is turned on under the control of the control unit 240, and the pair of output lines (the odd output and the even output) may share charge.

When the first charge sharing period tcs1 is changed to the second panel charging/discharging period tcd2, the output switch unit 220 is turned on under the control of the control unit 240, and supplies the pair of output lines (the odd output and the even output) with the pixel signal that is output from the output buffer unit 210. Similarly, the charge sharing switch unit 230 is turned off under the control of the control unit 240.

When the second panel charging/discharging period tcd2 is changed to the second charge sharing period tcs2 in which there is no polarity inversion (polarity non-inversion), the output switch unit 220 is turned off under the control of the control unit 240, and the pixel signal output from the output buffer unit 210 is not transferred to the display panel (not illustrated). Simultaneously, the first charge sharing switch SW5-1 is turned on under the control of the control unit 240. However, the second charge sharing switch SW5-n maintains a turn-off state and the pair of output lines (the odd output and the even output) share charge by the first charge sharing switch SW5-1. That is, charge sharing is limited.

Since the charge sharing of the pair of output lines (the odd output and the even output) is performed only through the first charge sharing switch SW5-1, a change in the voltages of the pair of output lines (the odd output and the even output) is reduced as compared with the first charge sharing period tcs1. Consequently, when the second charge sharing period tcs2 is changed to the third panel charging/discharging period tcd3, power consumption of the pair of output lines (the odd output and the even output) can be reduced.

In the display driving circuit 200 according to the present invention, the pair of output lines (the odd output and the even output) supply only power corresponding to the difference between a voltage corresponding to a current pixel signal and a voltage corresponding to a previous pixel signal. Consequently, the display driving circuit 200 according to the present invention can reduce power consumption.

For example, when a valid data voltage of the first output line (the odd output) is 9 V in the first panel charging/discharging period tcd1 and is 9 V in the second panel charging/discharging period tcd2, since the voltage of the first output line (the odd output) is lowered to 4.5 V by passing through the charge sharing period tcs1 in the conventional art, it is necessary to increase the voltage of 4.5 V in correspondence with the second panel charging/discharging period tcd2. However, in the present invention, since the voltage of the first output line maintains 5.5 V higher than 4.5 V in the charge sharing period tcs2, it has only to increase the voltage of 3.5 V in correspondence with the next third panel charging/discharging period tcd3. As a consequence, the display driving circuit 200 according to the present invention can reduce power consumption for a voltage increase by 1.0 V as compared with the conventional art, wherein 1.0 V is temporary, but is a voltage corresponding to 22.2% as compared with the conventional art.

Table 2 below indicates a simulation result for power consumption and heat generation of the display driving circuits according to the conventional art and the present invention.

TABLE 2

| | Current | Power | Driving circuit |
|---|---|---|---|
| | consumption | consumption | temperature |
| | [mA] | [mW] | [° C.] |
| Conventional | 55.2 | 938 | 105 |
| art | | | |
| Present | 49.8 | 847 | 97 |
| invention | | | |
| Difference | 5.4 | 91 | 8 |

Referring to Table 2 above, according to a simulation result of white screen driving in polarity non-inversion, it can be understood that the display driving circuit 200 according to the present invention reduces current consumption and power consumption by about 10% (91/938), and reduces heat generation by about 8% (8/105) as compared with the conventional art.

The display driving circuit 200 can control a time or a speed required for reaching a normal state by adjusting a connection resistance value of the charge sharing switch unit 230 in consideration of the characteristics of a time amplitude response curve of an RC circuit, thereby minimizing power consumption and heat generation.

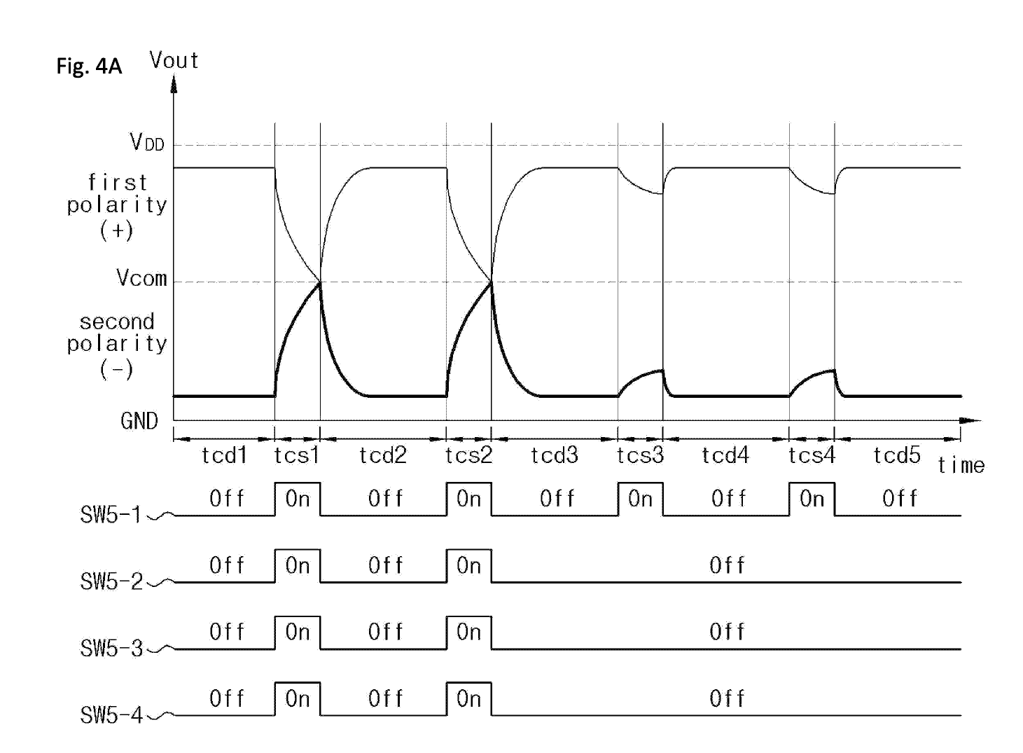

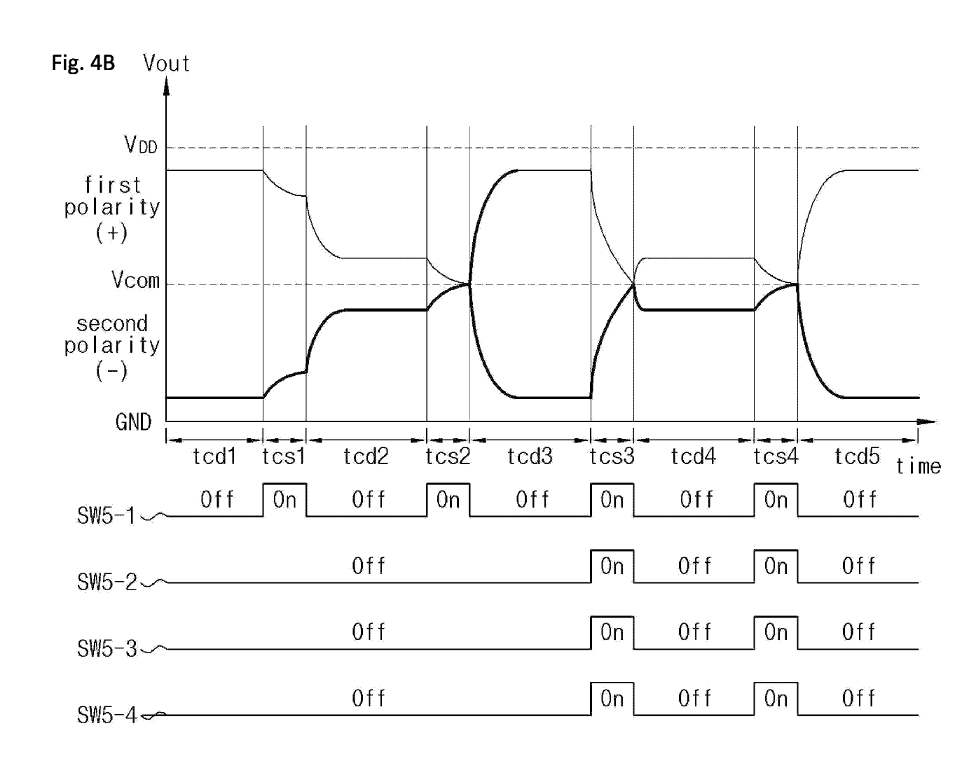

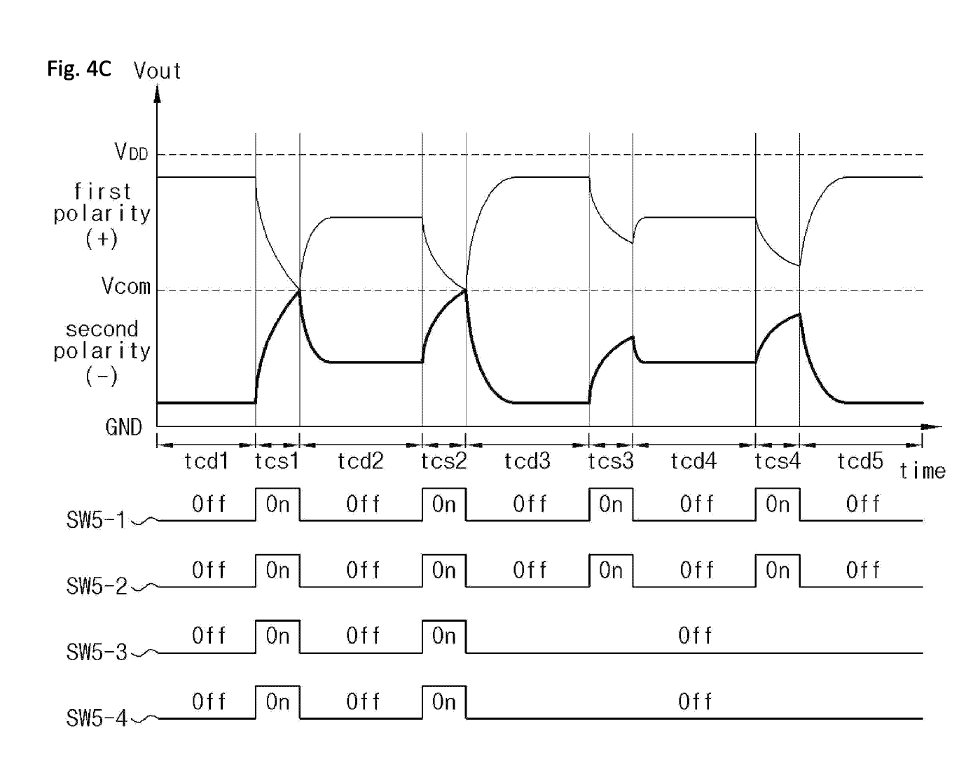

FIG. 4A to FIG. 4C are a waveform diagram illustrating the operation of the charge sharing switch unit 230 according to a change in the output of the display driving circuit.

Referring to FIG. 4A to FIG. 4C, in the polarity inversion period of the display driving circuit 200, since the operation of the charge sharing switch unit 230 is the same as described above, the polarity inversion period is excluded, and the charge sharing switch unit 230 may include four charge sharing switches SW5-1 to SW5-4.

FIG. 4A corresponds to the case in which power consumption of the display driving circuit is high as with a white screen.

In first and second panel charging/discharging periods tcd1 and tcd2, the charge sharing switches SW5-1 to SW5-4 maintain a turn-off state under the control of the control unit 240.

When the first and second panel charging/discharging periods tcd1 and tcd2 are changed to first and second charge sharing periods tcs1 and tcs2, the charge sharing switches SW5-1 to SW5-4 are turned on under the control of the control unit 240, so that the pair of output lines (the odd output and the even output) may share charge that exists in the display panel and is to be discharged.

Then, when the second charge sharing period tcs2 is changed to a third panel charging/discharging period tcd3, the charge sharing switches SW5-1 to SW5-4 are turned off under the control of the control unit 240.

The control unit 240 may receive power consumption information of the display driving circuit 200 in a specific period from an exterior.

In an embodiment, the control unit 240 may calculate a power consumption variation in the specific period based on the received power consumption information, and generate a control signal such that a connection resistance value of the charge sharing switch unit 230 is adjusted step by step according to a preset reference.

For example, the control unit 240 may power consumption information, which represents that power of 1200 mW has been averagely consumed for the first to third panel charging/discharging period tcd1 to tcd3, from a power supply unit (not illustrated) that supplies power to the display driving circuit 200. At this time, the control unit 240 may control only one first charge sharing switch SW5-1 to operate for the specific period from a next charge sharing period based on a table such as Table 1 as described above.

Referring again to FIG. 4B, when the third panel charging/discharging period tcd3 is changed to a third charge sharing period tcs3, only one charge sharing switch SW5-1 is turned on under the control of the control unit 240, so that the pair of output lines (the odd output and the even output) may share a small amount of charge as compared with the first charge sharing period tcs1.

Consequently, as a change width of the potential of the display driving circuit 200 is reduced, it is possible to reduce the power consumption of the display driving circuit 200 as compared with the conventional art.

FIG. 4B corresponds to the case in which a white screen and a black screen are alternately displayed.

Referring to FIG. 4B, similarly to the case of FIG. 4A, the control unit 240 may receive information on the power consumption of the display driving circuit 200 in the third panel charging/discharging period tcd3 from an exterior.

The control unit 240 may calculate a power consumption variation based on the received power consumption information.

For example, the control unit 240 may calculate the power consumption variation based on power consumption information for the first to third panel charging/discharging periods tcd1 to tcd3. In more detail, in the first to third panel charging/discharging periods tcd1 to tcd3, the control unit 240 may receive power consumption information corresponding to 1200 mW, 300 mW, and 1200 mW. Based on the received power consumption information, the control unit 240 may calculate a power consumption variation corresponding to average 900 mW. Consequently, the control unit 240 can control all the charge sharing switches SW5-1 to SW5-4 to operate based on a switch control table (not illustrated) according to the power consumption variation.

Referring again to FIG. 4B, when the third panel charging/discharging period tcd3 is changed to the third charge sharing period tcs3, all the charge sharing switches SW5-1 to SW5-4 are turned on under the control of the control unit 240, so that the pair of output lines (the odd output and the even output) may share a large amount of charge as compared with the first and second charge sharing periods tcs1 and tcs2.

FIG. 4C corresponds to the case in which a white screen and a normal screen (a potential change in an output voltage is normal) are alternately displayed.

Referring to FIG. 4C, similarly to the case of FIG. 4B, the control unit 240 may receive the power consumption information of the display driving circuit 200 in the first to third panel charging/discharging periods tcd1 to tcd3, and calculate a power consumption variation based on the received power consumption information.

For example, in the first to third panel charging/discharging periods tcd1 to tcd3, the control unit 240 may receive power consumption information corresponding to 1200 mW, 600 mW, and 1200 mW, and calculate a power consumption variation corresponding to average 600 mW.

The control unit 240 can control only two charge sharing switches SW5-1 and SW5-2 to operate based on a switch table according to the power consumption variation.

Referring again to FIG. 4C, when the third panel charging/discharging period tcd3 is changed to the third charge sharing period tcs3, only the two charge sharing switches SW5-1 and SW5-2 are turned on under the control of the control unit 240, so that the pair of output lines (the odd output and the even output) may share a small amount of charge as compared with the first and second charge sharing periods tcs1 and tcs2.

Consequently, the charge sharing switch unit 230 is dynamically controlled according to a change in the power consumption of the display driving circuit 200, so that it is possible to reduce power consumption as compared with the conventional art.

In the present embodiments, the case in which the number of charge sharing switches is four has been described as an example; however, the present invention is not limited thereto, and the number of charge sharing switches may be expanded to three or five more according to a product application example.

In an embodiment, the display driving circuit 200 may further include a polarity detector 250 that detects the polarity inversion of the display panel.

The polarity detector 250 may directly or indirectly receive a signal associated with the polarity of the display panel from an exterior, and determine the presence or absence of the polarity inversion.

In more detail, the polarity detector 250 may receive a polarity signal for deciding the polarity of a data voltage supplied to a separate display panel from an exterior, and determine the presence or absence of the polarity inversion.

The polarity signal is a signal that is generally used in a display driving circuit, and performs a function of controlling the display driving circuit.

Differently from this, the polarity detector 250 may be configured to determine the presence or absence of the polarity inversion based on a control signal extracted from packet data received from an exterior. The packet data may have a clock embedded differential signal (CEDS) scheme in which a clock signal is embedded in an image data signal, wherein a clock signal, a control signal, and display data may be extracted from the packet data by a restoration circuit (not illustrated) by a predetermined process, and the extracted clock signal, control signal, and display data may be used in the polarity detector 250.

The control unit 240 may receive information regarding the presence or absence of the polarity inversion from the polarity detector 250, and control the operations of the output switch unit 220 and the charge sharing switch unit 230.

The control unit 240 may receive the display data (for example, a pixel signal) from the polarity detector 250, calculate a variation in the display data, and control the operation of the charge sharing switch unit 230 step by step according to a change in the display data based on the calculated variation.

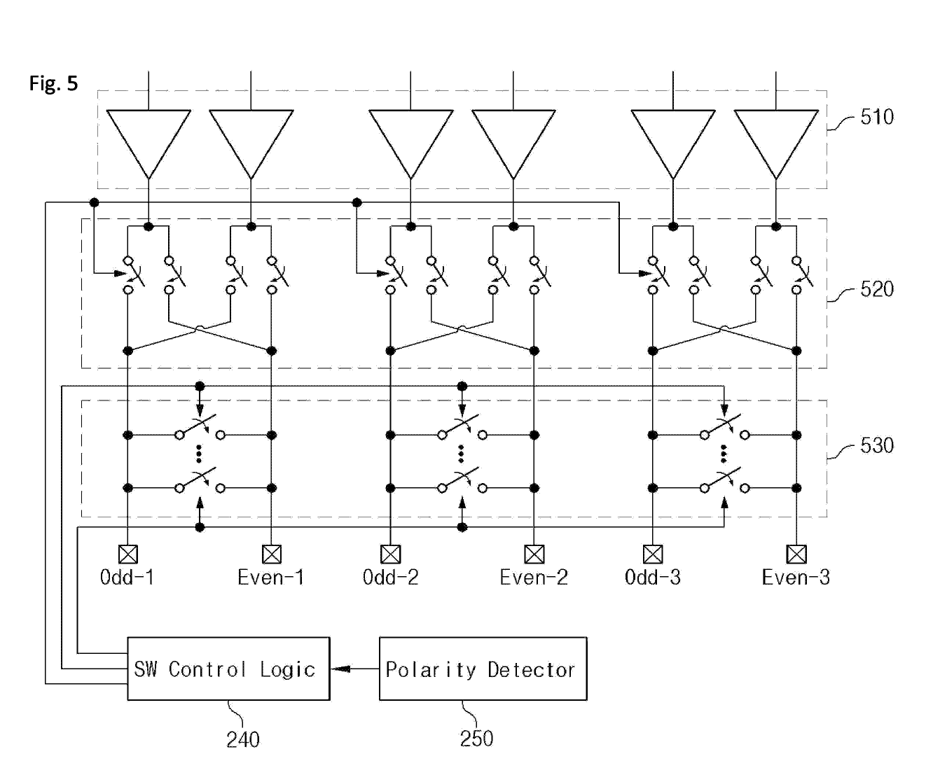

FIG. 5 is a diagram illustrating a display driving circuit according to another embodiment of the present invention.

Referring to FIG. 5, a display driving circuit 200 includes an output buffer unit 510 having a plurality of output line pairs, an output switch unit 520 having a plurality of output switches, a charge sharing switch unit 530 that interconnects the output lines, a control unit 240, and a polarity detector 250. In FIG. 5, the output line pairs are indicated by Odd-1 and Even-1, Odd-2 and Even-2, and Odd-3 and Even-3. The Odd-1, the Odd-2, and the Odd-3 correspond to the output lines (Odd Output) of FIG. 2, and the Even-1, the Even-2, and the Even-3 correspond to the output lines (Even Output) of FIG. 2.

The output buffer unit 510 operates similarly to the output buffer unit 210 described above, and the output switch unit 520 and the charge sharing switch unit 530 also operate similarly to the output switch unit 220 and the charge sharing switch unit 230 described above.

A display device includes a display panel and a display driving circuit that drives the display panel, wherein the display driving circuit includes at least one output buffer pair 210, an output switch unit 220 that connects the output buffer pairs to output line pairs, a charge sharing switch unit 230 that connects/disconnects the output line pairs to/from each other, and a control unit 240 that controls the output switch unit 220 and the charge sharing switch unit 230.

While various embodiments have been described above, it will be understood to those skilled in the art that the embodiments described are by way of example only. Accordingly, the disclosure described herein should not be limited based on the described embodiments.

What is claimed is:

1. A display driving circuit comprising:
an output buffer unit that outputs a pair of pixel signals;
an output switch unit that directly transfers the pair of pixel signals to a pair of output lines or transfers the pair of pixel signals to the pair of output lines such that the pair of pixel signals cross each other in correspondence with repetitive panel charging/discharging periods; and
a charge sharing switch unit that controls charge sharing of the pair of output lines in correspondence with a charge sharing period between the panel charging/discharging periods, and has a variable connection resistance value in correspondence with the variation of the pair of pixel signals.

2. The display driving circuit according to claim 1, further comprising:
a control unit that controls the connection resistance value of the charge sharing switch unit.

3. The display driving circuit according to claim 2, wherein the control unit controls the connection resistance value based on a change in levels of the pixel signals.

4. The display driving circuit according to claim 2, wherein the control unit controls the connection resistance value based on at least one of power consumption and heat generation.

5. The display driving circuit according to claim 4, wherein the control unit calculates a variation for the power consumption and controls the connection resistance value step by step according to a preset reference.

6. The display driving circuit according to claim 1, wherein the charge sharing switch unit provides variable the connection resistance value in correspondence with a change in polarities of the pixel signals that are output from the pair of output lines.

7. The display driving circuit according to claim 6, wherein the charge sharing switch unit provides a large connection resistance value in polarity non-inversion of the pixel signals that are output from the pair of output lines, as compared with polarity inversion of the pixel signals.

8. The display driving circuit according to claim 1, wherein the charge sharing switch unit comprises:
a first charge sharing switch that interconnects the pair of output lines in correspondence with the charge sharing period; and
at least one second charge sharing switch that interconnects the pair of output lines in correspondence with polarity inversion of the pair of pixel signals that are output from the pair of output lines in the charge sharing period.

9. The display driving circuit according to claim 8, wherein the first charge sharing switch and the at least one second charge sharing switch have the connection resistance value, and the first charge sharing switch and the at least one second charge sharing switch are connected in parallel to each other.

10. The display driving circuit according to claim 1, further comprising:
a control unit that controls an operation of the output switch unit and the connection resistance value of the charge sharing switch unit,
wherein the control unit controls the operation of the output switch unit such that the pair of pixel signals are directly transferred to the pair of output lines or are transferred to the pair of output lines by crossing each other in the panel charging/discharging periods, and controls charge sharing of the pair of output lines such that the charge sharing switch unit has the variable connection resistance value in the charge sharing period.

11. The display driving circuit according to claim 10, wherein the charge sharing switch unit comprises:
a plurality of charge sharing switches connected to the pair of output lines in parallel to each other,
wherein the control unit controls a predetermined number of charge sharing switches to participate in charge sharing, and controls a number of the charge sharing switches participating in the charge sharing in correspondence with a change in power consumption.

12. The display driving circuit according to claim 1, further comprising:
a control unit that controls an operation of the output switch unit and the connection resistance value of the charge sharing switch unit,
wherein the control unit controls the operation of the output switch unit such that the pair of pixel signals are directly transferred to the pair of output lines or are transferred to the pair of output lines by crossing each other in the panel charging/discharging periods, controls charge sharing of the pair of output lines by controlling the charge sharing switch unit to have a first connection resistance value in correspondence with polarity non-inversion of the pair of pixel signals of the pair of output lines in the charge sharing period, and controls the charge sharing of the pair of output lines by controlling the charge sharing switch unit to have a second connection resistance value in correspondence with polarity inversion of the pair of pixel signals of the pair of output lines in the charge sharing period.

13. The display driving circuit according to claim 12, wherein the charge sharing switch unit comprises:
a first charge sharing switch and at least one second charge sharing switch connected in parallel to each other between the pair of output lines,
wherein, in the charge sharing period, the control units operates the first charge sharing switch in correspondence with the polarity non-inversion, and further operates the at least one second charge sharing switch in correspondence with the polarity inversion.

14. The display driving circuit according to claim 1, further comprising:
a control unit that controls the connection resistance value of the charge sharing switch unit; and
a polarity detector that provides the control unit with information corresponding to a change in polarities of the pair of pixel signals that are output from the pair of output lines.

15. The display driving circuit according to claim 14, wherein the polarity detector receives a signal associated with a polarity of a display panel from an exterior, and detects polarity inversion of the display panel.

16. The display driving circuit according to claim 1, wherein the charge sharing switch unit allows a change in the pair of pixel signals of the pair of output lines in the charge sharing period to be small in polarity non-inversion as compared with polarity inversion.

17. A display driving circuit comprising:
an output buffer unit that outputs a plurality of pixel signal pairs;
an output switch unit that directly transfers the plurality of pixel signal pairs to a plurality of output line pairs or transfers the plurality of pixel signal pairs to the plurality of output line pairs such that the plurality of pixel signal pairs cross each other in units of pairs corresponding to each other;
a charge sharing switch unit that includes at least one switch that operates for charge sharing in units of pairs corresponding to each other of the plurality of output line pairs, and provides a variable connection resistance value by an operation of the switch; and
a control unit that controls operations of the output switch unit and the charge sharing switch unit.

18. A display device comprising:
a display panel; and
a display driving circuit that drives the display panel,
wherein the display driving circuit comprises:
an output buffer unit that outputs a pair of pixel signals;
an output switch unit that directly transfers a pair of pixel signals to a pair of output lines or transfers the pair of pixel signals to the pair of output lines such that the pair of pixel signals cross each other;
a charge sharing switch unit that includes at least one switch that operates for charge sharing of the pair of output lines, and provides a variable connection resistance value by an operation of the switch; and
a control unit that controls operations of the output switch unit and the charge sharing switch unit.
